(19) United States
(12) Patent Application Publication
(10) Pub. No.: US 2011/0031311 A1
(43) Pub. Date: Feb. 10, 2011

(54) KEYFOB AND IN STORE DEVICE BASED PROMOTION GENERATION SYSTEM AND METHOD

(75) Inventor: Anton Bakker, Norfolk, VA (US)

Correspondence Address: The Villamar Firm PLLC, 3424 Washington Drive, Falls Church, VA, 22041, US

(73) Assignee: OUTSITE NETWORKS, INC., Norfolk, VA (US)

(21) Appl. No.: 12/852,626

(22) Filed: Aug. 9, 2010

Related U.S. Application Data
(60) Provisional application No. 61/232,645, filed on Aug. 10, 2009.

(51) Int. Cl. G06K 15/00

(52) U.S. Cl. 235/383

(57) ABSTRACT

A system, method and computer program product for promotion generation and processing, including a keyfob device; a store device associated with a promotion and configured to communicate with the keyfob device, wherein based on a communication with the keyfob device the store device is configured to associate the promotion with the keyfob device; and a point-of-sale (POS) system, wherein the promotion associated with the keyfob device is communicated to the POS system for processing the promotion and for generating a corresponding sales slip including the promotion.

### CROSS REFERENCE TO RELATED APPLICATIONS

The present invention claims benefit of priority to U.S. Provisional Patent Application Ser. No. 61/232,645 of BAKKER, entitled “KEYFOB AND IN STORE DEVICE BASED PROMOTION GENERATION SYSTEM AND METHOD,” filed on Aug. 10, 2009, the entire disclosure of which is hereby incorporated by reference herein.

### BACKGROUND OF THE INVENTION

1. Field of the Invention

The present invention generally relates to systems and methods for processing promotions at point-of-sale (POS) systems, and more particularly to a system and method for processing and generation of promotions at POS systems based on keyfobs and devices provided in store, for example, on store shelves, store pallets, adjacent to items on sale or being promoted, and the like.

2. Discussion of the Background

Paper copy promotions have been employed for numerous years in stores for processing at point-of-sale (POS) systems. However, the present promotion systems and methods typically are only configured for processing items with respect to paper copy promotions.

### SUMMARY OF THE INVENTION

Therefore, there is a need for a method and system that addresses the above and other problems with conventional systems and methods for processing promotions. The above and other problems are addressed by the exemplary embodiments of the present invention, which provide a novel system and method for generating and processing promotions at point-of-sale (POS) systems based on devices (e.g., radio-frequency identification (RFID) based devices, and the like) provided in stores. For example, based on RFID communications between a keyfob device and an in store device, promotions are linked with the keyfob device, stored on the keyfob device, and the like. The keyfob device then communicates with a POS system so that the corresponding promotions are received by the POS system for processing. Advantageously, the promotions can be configured as incentives, coupons, and the like, and processed by the POS system along with purchased products for generating a sales receipt.

Accordingly, in exemplary aspects of the present invention there is provided a system, method and computer program product for promotion generation and processing, including a keyfob device; a store device associated with a promotion and configured to communicate with the keyfob device, wherein based on a communication with the keyfob device the store device is configured to associate the promotion with the keyfob device; and a point-of-sale (POS) system, wherein the promotion associated with the keyfob device is communicated to the POS system for processing the promotion and for generating a corresponding sales slip including the promotion.

Still other aspects, features, and advantages of the present invention are readily apparent from the following detailed description, by illustrating a number of exemplary embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 illustrates an exemplary promotion generation and processing system; and

FIG. 2 illustrates an exemplary flow chart corresponding to the promotion generation and processing system of FIG. 1.

### DETAILED DESCRIPTION OF THE PREFERRED EMBODIMENTS

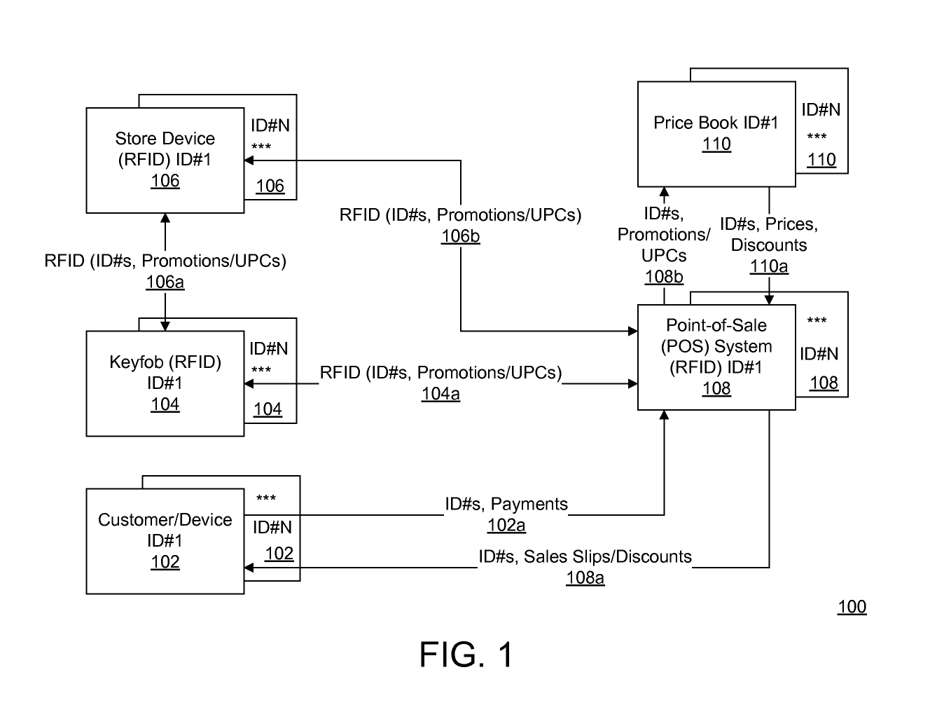

Referring now to the drawings, wherein like reference numerals designate identical or corresponding parts throughout the several views, and more particularly to FIG. 1 thereof, there is illustrated an exemplary promotion generation and processing system 100. In FIG. 1, the system 100 includes one or more customers or customer devices 102 that are associated with one or more respective keyfob devices 104. The system 100 further includes one or more store devices 106 that are provided at various locations within the store, for example, on the shelves of the store (e.g., beverage shelves, food shelves, medicine shelve, and the like) and which store respective promotions (e.g., beverage promotions, food promotions, medicine promotions, and the like). In further exemplary embodiments, the store devices 106 can be provided at any suitable location, for example, including store pallets, adjacent to items on sale or being promoted, and the like. The keyfob devices 104 communicate via a bidirectional communications link 106a (e.g., based on radio-frequency identification (RFID) communications, and the like) with the store devices 106, which transmit, link, and the like, the promotions stored in the store devices 106, associated with the store devices 106, and the like, to the keyfob devices 104 via the communications link 106a. During check out, the keyfob devices 104 communicate via a bidirectional communications link 104a (e.g., based on radio-frequency identification (RFID) communications, and the like) with one or more point-of-sale (POS) systems 108 (e.g., RFID equipped POS systems, including POS terminals, clients, servers, in store processors, databases, and the like). The promotions stored on the keyfob devices 104, linked with the keyfob devices 104, and the like, are then communicated to the POS systems 108 for promotions processing and verification. In further exemplary embodiments, the store devices 106 also can communicate directly via a bidirectional communications link 106b (e.g., based on radio-frequency identification (RFID) communications, and the like) with the one or more POS systems 108 to communicate the promotions associated with the keyfob devices 104 to POS systems 108.

The POS systems 108 generate sales slips 108a for processing payments 102a from the customer or devices 102. The POS systems 108, based on the promotions associated with the keyfob devices 104, determine the discounts corresponding to the promotions for generating the sales slip 108a. Advantageously, if a promotion corresponds to a discount, the discount is included along with any other processed items or coupons in the generated sales slip 108a. For example, if the an item presented and confined as being purchased by the POS systems 108 is soda pop with a price of one dollar ($1.00) and the promotion corresponds to a discount of 50 cents ($0.50), the resulting sales slip 108a would be for 50 cents ($1.00-$0.50). In a similar manner, the promotions can be configured as virtual coupons, incentives, and the like.

In further exemplary embodiments, the POS systems 108 query respective price books 110 via a bidirectional communications link 108b to determine the discounts 110a corresponding to the promotions for generating the sales slip 108a, wherein the devices or components 102, 104, 106, 108 and 110 can include respective unique identification numbers (IDs) for uniquely identifying each of the devices, and the promotions can include Universal Product Codes (UPCs) for processing by the POS systems 108 and the price books 110. Accordingly, although the store devices 106 can transmit promotions directly to the keyfob devices 104, in further exemplary embodiments, the store devices 106 can transmit the IDs of the store devices 106, which are linked to promotions at the POS system 108 level or at an interface to the POS system 108, and the like. Thus, the IDs of the store devices 106 are linked to promotions and associated with the keyfob devices 104. This can be done through a table mapping the IDs of the store devices 106 to IDs of promotion or directly to UPC codes corresponding to the promotions.

In a similar manner, the IDs (e.g., RFIDs) of the keyfob devices 104 can be linked to the IDs of the store devices 106. The IDs of the keyfob devices 104 then are linked to the IDs and/or UPC codes of the promotions. The IDs or UPC codes of the promotions then are communicated to the POS system 108 at the time that the keyfob devices 104 are presented at the POS system 108 terminal, cash register, and the like, at the time of a transaction. The IDs or UPC codes of the promotions can be carried on the RFID tag of the keyfob devices 104 or the store devices 106 can track the RFID identities of the keyfob devices 104 and communicate the promotions to the POS system 108 at the time that the keyfob devices 104 are presented to the POS system 108 terminal, cash register, and the like. The POS system 108 terminal, cash register, and the like, also includes a unique ID in order for the POS system 108 to apply the promotions to the corresponding terminal, cash register, and the like, of the POS system 108.

Accordingly, the promotions can be linked to the IDs of the store devices 106, and the IDs/promotions for the store devices 106 may or may not be carried on the RFID tags of the keyfob devices 104. If they are not carried on the RFID tags of the keyfob devices 104, then the store devices 106 can capture the IDS of the keyfob devices 104 and link the IDS to the IDs/promotions of the store devices 106 in order to make the promotions known to the POS system 108 at the time that the keyfob devices 104 are presented to the terminal, cash register, and the like, of the POS system 108.

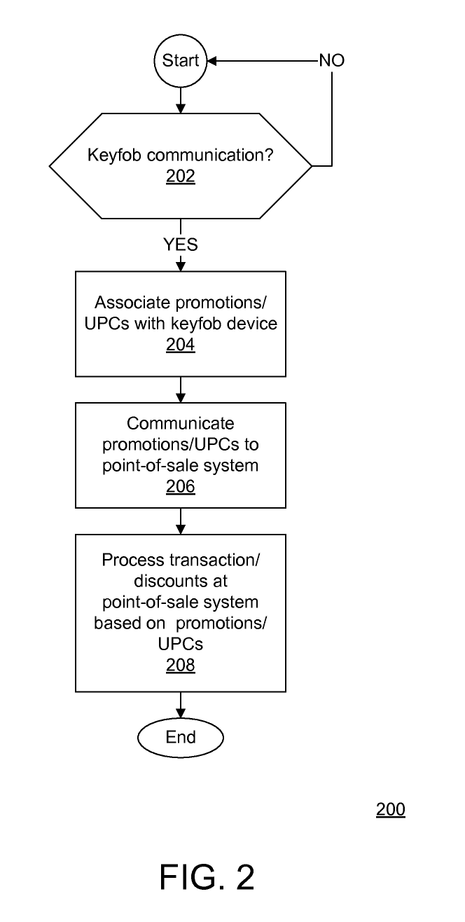

FIG. 2 illustrates an exemplary flow chart 200 corresponding to the promotion generation and processing system 100 of FIG. 1. In FIG. 2, at step 202, the store devices 106 determine if a communication has been received from the keyfob devices 104. If a communication has not been received from the keyfob devices 104, as determined by step 202, control returns to step 202. If, however, a communication has been received from the keyfob devices 104, the store devices 106, at step 204, associate the corresponding promotions with keyfob devices 104. During check out, the promotions stored on and/or associated with the keyfob devices 104 are communicated to the POS systems 108, which at step 208 process the promotions for generating the corresponding sales slips 108a for the payments 102a, completing the process.

In further exemplary embodiments, the system 100 can also be configured to allow users to enter an identification number (e.g., a phone number, etc.) rather than employing the RFID tags of the keyfob devices 104.

The above-described devices and subsystems of the exemplary embodiments of FIGS. 1-2 can include, for example, any suitable servers, workstations, PCs, laptop computers, PDAs, Internet appliances, handheld devices, cellular telephones, wireless devices, other devices, and the like, capable of performing the processes of the exemplary embodiments of FIGS. 1-2. The devices and subsystems of the exemplary embodiments of FIGS. 1-2 can communicate with each other using any suitable protocol and can be implemented using one or more programmed computer systems or devices.

One or more interface mechanisms can be used with the exemplary embodiments of FIGS. 1-2, including, for example, Internet access, telecommunications in any suitable form (e.g., voice, modem, and the like), wireless communications media, and the like. For example, the employed communications networks can include one or more wireless communications networks, cellular communications networks, 3 G communications networks, Public Switched Telephone Network (PSTNs), Packet Data Networks (PDNs), the Internet, intranets, a combination thereof, and the like. Accordingly, the devices and subsystems of the exemplary embodiments can be implemented on the World Wide Web.

It is to be understood that the devices and subsystems of the exemplary embodiments of FIGS. 1-2 are for exemplary purposes, as many variations of the specific hardware and/or software used to implement the exemplary embodiments are possible, as will be appreciated by those skilled in the relevant art(s). For example, the functionality of one or more of the devices and subsystems of the exemplary embodiments of FIGS. 1-2 can be implemented via one or more programmed computer systems or devices.

To implement such variations as well as other variations, a single computer system can be programmed to perform the special purpose functions of one or more of the devices and subsystems of the exemplary embodiments of FIGS. 1-2. On the other hand, two or more programmed computer systems or devices can be substituted for any one of the devices and subsystems of the exemplary embodiments of FIGS. 1-2. Accordingly, principles and advantages of distributed processing, such as redundancy, replication, and the like, also can be implemented, as desired, to increase the robustness and performance the devices and subsystems of the exemplary embodiments of FIGS. 1-2.

The devices and subsystems of the exemplary embodiments of FIGS. 1-2 can store information relating to various processes described herein. This information can be stored in one or more memories, such as a hard disk, optical disk, magneto-optical disk, RAM, and the like, of the devices and subsystems of the exemplary embodiments of FIGS. 1-2. One or more databases of the devices and subsystems of the exemplary embodiments of FIGS. 1-2 can store the information used to implement the exemplary embodiments of the present invention. The databases can be organized using data structures (e.g., records, tables, arrays, fields, graphs, trees, lists, and the like) included in one or more memories or storage devices listed herein. The processes described with respect to the exemplary embodiments of FIGS. 1-2 can include appropriate data structures for storing data collected and/or generated by the processes of the devices and subsystems of the exemplary embodiments of FIGS. 1-2 in one or more databases thereof.

All or a portion of the devices and subsystems of the exemplary embodiments of FIGS. 1-2 can be conveniently implemented using one or more general purpose computer systems, microprocessors, digital signal processors, micro-controllers, and the like, programmed according to the teachings of the exemplary embodiments of the present invention, as will be appreciated by those skilled in the computer and software arts. Appropriate software can be readily prepared by programmers of ordinary skill based on the teachings of the exemplary embodiments, as will be appreciated by those skilled in the software art. In addition, the devices and subsystems of the exemplary embodiments of FIGS. 1-2 can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present invention can include software for controlling the devices and subsystems of the exemplary embodiments of FIGS. 1-2, for driving the devices and subsystems of the exemplary embodiments of FIGS. 1-2, for enabling the devices and subsystems of the exemplary embodiments of FIGS. 1-2 to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementing the exemplary embodiments of FIGS. 1-2. Computer code devices of the exemplary embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present invention can be distributed for better performance, reliability, cost, and the like.

As stated above, the devices and subsystems of the exemplary embodiments of FIGS. 1-2 can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

While the present invention have been described in connection with a number of exemplary embodiments and implementations, the present invention is not so limited, but rather covers various modifications and equivalent arrangements, which fall within the purview of the appended claims.

What is claimed is:

1. A system for promotion generation and processing, the system comprising:
a keyfob device;
a store device associated with a promotion and configured to communicate with the keyfob device,
wherein based on a communication with the keyfob device the store device is configured to associate the promotion with the keyfob device; and
a point-of-sale (POS) system,
wherein the promotion associated with the keyfob device is communicated to the POS system for processing the promotion and for generating a corresponding sales slip including the promotion.

2. The system of claim 1, wherein the keyfob device is configured to communicate with the store device and/or the POS system using radio-frequency identification (RFID) communications.

3. The system of claim 1, wherein the store device is configured to communicate with the keyfob device and/or the POS system using radio-frequency identification (RFID) communications.

4. The system of claim 1, wherein the keyfob device, the store device, the POS system, and the promotion include respective unique identification numbers used during communications.

5. A method for promotion generation and processing, the method comprising:
communicating with a keyfob device via a store device associated with a promotion;
associating by the store device the promotion with the keyfob device based on a communication with the keyfob device; and
communicating the promotion associated with the keyfob device to a point-of-sale (POS) system for processing the promotion and for generating a corresponding sales slip including the promotion.

6. The method of claim 5, wherein the keyfob device is configured to communicate with the store device and/or the POS system using radio-frequency identification (RFID) communications.

7. The method of claim 5, wherein the store device is configured to communicate with the keyfob device and/or the POS system using radio-frequency identification (RFID) communications.

8. The method of claim 5, wherein the keyfob device, the store device, the POS system, and the promotion include respective unique identification numbers used during communications.

9. A computer program product for promotion generation and processing and including one or more computer readable instructions embedded on a computer readable medium and configured to cause one or more computer processors to perform the steps of:
communicating with a keyfob device via a store device associated with a promotion;
associating by the store device the promotion with the keyfob device based on a communication with the keyfob device; and
communicating the promotion associated with the keyfob device to a point-of-sale (POS) system for processing the promotion and for generating a corresponding sales slip including the promotion.

10. The computer program product of claim 9, wherein the keyfob device is configured to communicate with the store device and/or the POS system using radio-frequency identification (RFID) communications.

11. The computer program product of claim 9, wherein the store device is configured to communicate with the keyfob device and/or the POS system using radio-frequency identification (RFID) communications.

12. The computer program product of claim 9, wherein the keyfob device, the store device, the POS system, and the promotion include respective unique identification numbers used during communications.
